(19) United States
(12) Patent Application Publication
(10) Pub. No.: US 2012/0182682 A1
(43) Pub. Date: Jul. 19, 2012

(54) PROGRAMMING APPARATUS FOR SYSTEM MANAGEMENT BUS INTERFACE MEMORY CHIP

(75) Inventor: Yun Lou, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/011,944

(22) Filed: Jan. 24, 2011

(30) Foreign Application Priority Data
Jan. 19, 2011 (CN) 201110021923.1

(51) Int. Cl. G06F 1/16

(52) U.S. Cl. 361/679.31

(57) ABSTRACT

A programming apparatus includes a printed circuit board (PCB) and an SMBus memory chip adapter. When the PCB is inserted in a memory slot of a motherboard, a programmable chip inserted in the SMBus memory chip adapter can be programmed through or by the motherboard.

### BACKGROUND

1. Technical Field

The present disclosure relates to a programming apparatus for programming system management bus (SMBus) memory chips.

2. Description of Related Art

In general, SMBus memory chips are mostly programmed by a special integrated circuit (IC) programming device. However, the IC programming device may be costly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an embodiment of a programming apparatus.

FIG. 2 is a circuit diagram of the programming apparatus of FIG. 1.

FIG. 3 is an isometric view of the programming apparatus of FIG. 1, which is used to program a system management bus memory chip through a motherboard.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

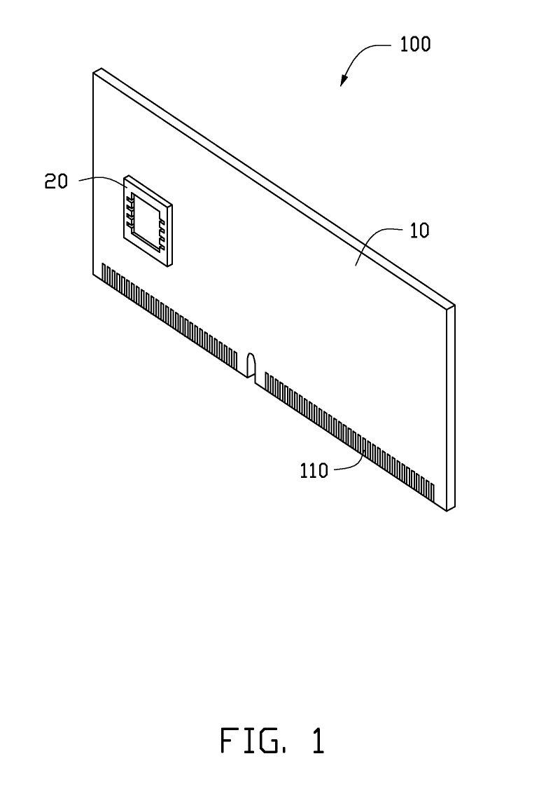

Referring to FIG. 1, an embodiment of a programming apparatus 100 used to program system management bus (SMBus) memory chips includes a printed circuit board (PCB) 10 and an SMBus memory chip adapter 20 mounted on the PCB 10. The PCB 10 includes a gold finger 110 used to be inserted in a memory slot of a computer motherboard.

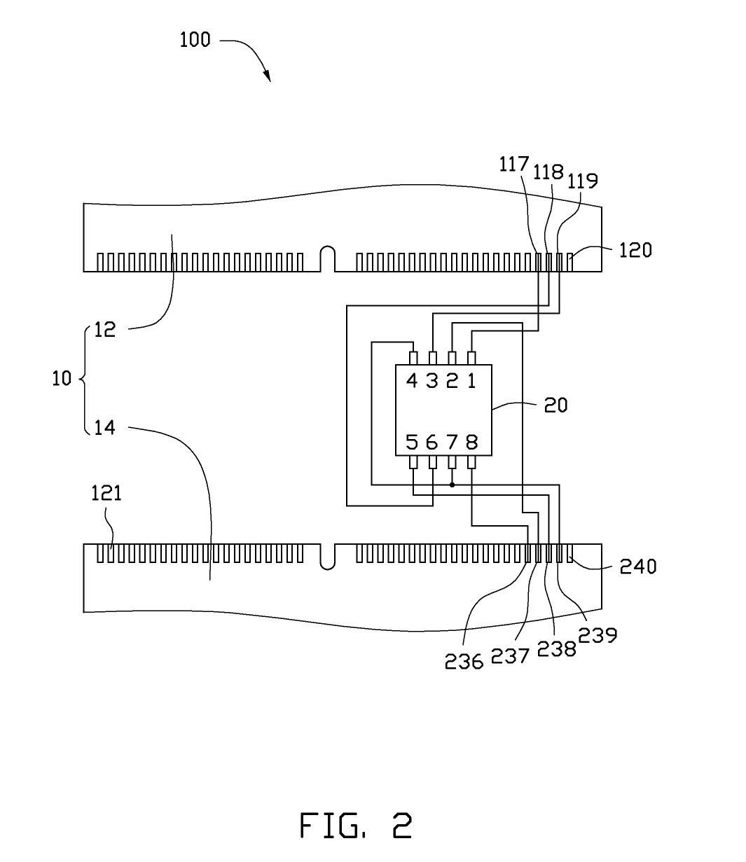

Referring to FIG. 2, in one embodiment, the gold finger 110 includes two hundred and twenty four pins 1-240 (FIG. 2 only shows a portion of them on a front side 12 and a back side 14 of the PCB 10). The chip adapter 20 includes eight pins 1-8, and the pins 1-8 of the chip adapter 20 are electrically connected to the pins 117, 237, 119, 239, 238, 118, 239, and 236 of the gold finger 110. The pins 117, 237, 119, 239, 238, 118, and 236 of the gold finger 110 are respectively a first address pin, a second address pin, a third address pin, a ground pin, a data pin, a clock pin, and a power pin. When the PCB 10 is inserted in the memory slot of the computer motherboard, the pins 117-119 and 236-239 of the gold finger 110 are corresponding electrically connected to an SMBus of the computer motherboard.

In one embodiment, the pin definition of the pins 1-8 of the chip adapter 20 is shown in the table below.

| Pin number | Pin definition |
|---|---|
| 1 | First address pin |
| 2 | Second address pin |
| 3 | Third address pin |
| 4 | Ground pin |
| 5 | Data pin |
| 6 | Clock pin |
| 7 | Write protection pin |
| 8 | Power pin |

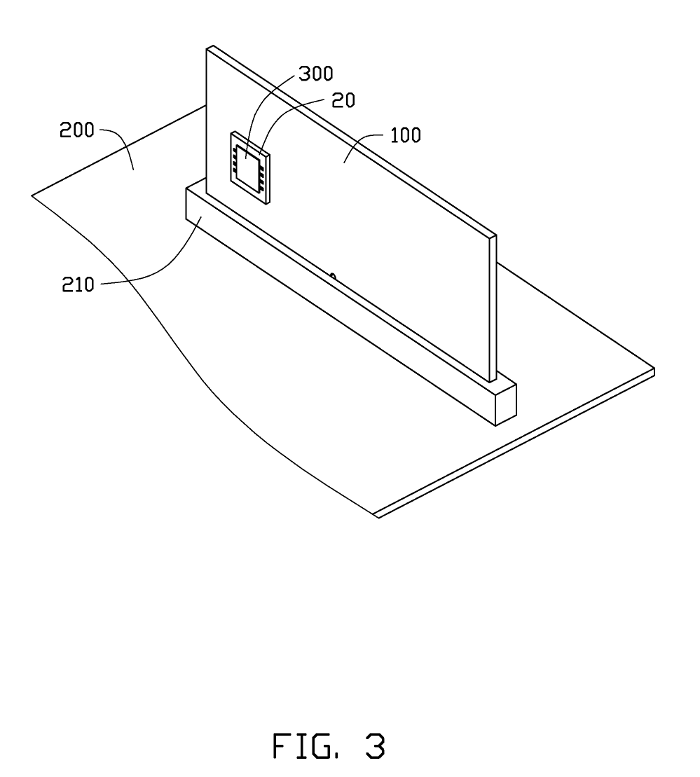

Referring to FIG. 3, in use, when an SMBus memory chip 300, such as an AT24CO4B chip, needs to be programmed, the SMBus memory chip 300 is inserted in the chip adapter 20. The pin definition of the SMBus memory chip 300 and the chip adapter 20 are same. The PCB 10 together with the SMBus memory chip 300 is inserted in a memory slot 210 of a computer motherboard 200. Therefore, the SMBus memory chip 300 can communicate with the SMBus of the computer motherboard 200 through the programming apparatus 100. The SMBus memory chip 300 can be programmed by the computer motherboard 200 executing corresponding programs, which is very convenient. The PCB 10 and the chip adapter 20 are very cheap, therefore the programming apparatus 100 is cheaper than a special integrated circuit (IC) programming device.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A programming apparatus for programming system management bus (SMBus) memory chips, the programming apparatus comprising:
a printed circuit board (PCB) comprising a gold finger which comprises a first address pin, a second address pin, a third address pin, a ground pin, a data pin, a clock pin, and a power pin, wherein the first address pin, the second address pin, the third address pin, the ground pin, the data pin, the clock pin, and the power pin of the gold finger are corresponding electrically connected to an SMBus of a computer motherboard in response to the gold finger being inserted in a memory slot of the computer motherboard; and
an SMBus memory chip adapter mounted on the PCB, wherein the SMBus memory chip adapter comprise a first address pin, a second address pin, a third address pin, a ground pin, a data pin, a clock pin, a write protection pin, and a power pin respectively connected to the first address pin, the second address pin, the third address pin, the ground pin, the data pin, the clock pin, the ground pin, and the power pin of the memory gold finger.
